(19) United States
(12) Patent Application Publication
(10) Pub. No.: US 2019/0207702 A1
(43) Pub. Date: Jul. 4, 2019

(54) OPTICAL RECEIVER

(71) Applicant: Nokia Solutions and Networks OY, Espoo (FI)

(72) Inventors: Doutje van Veen, New Providence, NJ (US); Vincent Houtsma, New Providence, NJ (US)

(73) Assignee: Nokia Solutions and Networks OY, Espoo (FI)

(21) Appl. No.: 15/858,449

(22) Filed: Dec. 29, 2017

(51) Int. Cl. H04J 14/08; H04B 10/61; H04B 10/50; H04B 10/27; H04B 10/572

(52) U.S. Cl. CPC H04J 14/08; H04B 10/616; H04B 10/572; H04B 10/27; H04B 10/503

(57) ABSTRACT

A coherent optical receiver capable of receiving data encoded in optical bursts whose optical power can vary significantly from burst to burst. In an example embodiment, the coherent optical receiver comprises a variable optical attenuator connected between an optical local oscillator and an optical hybrid and configured to controllably vary the intensity of the local-oscillator signal in response to a control signal generated by a control circuit. In an example embodiment, the control circuit is configured to generate the control signal for the variable optical attenuator using power-control settings read from a memory and further using a transmission schedule according to which different remote optical transmitters are scheduled to transmit their respective optical bursts. The power-control settings can be loaded into the memory, e.g., using a suitable calibration method configured to determine a respective nearly optimal coherent gain for receiving data from each of the remote optical transmitters.

### BACKGROUND

### Technical Field

The present disclosure relates to optical communication equipment and, more specifically but not exclusively, to equipment used in passive optical networks.

### Description of the Related Art

This section introduces aspects that may help facilitate a better understanding of the disclosure. Accordingly, the statements of this section are to be read in this light and are not to be understood as admissions about what is in the prior art or what is not in the prior art.

As used herein, the term “burst mode” refers to an operating mode in which an optical transmitter transmits data in selected time slots and does not transmit data in other time slots of a time division multiplexing communication scheme. That is, a burst-mode optical transmitter has data-burst intervals, in which the optical transmitter transmits a data burst, and idle intervals, in which the optical transmitter does not transmit a data burst. In some systems, the idle intervals of a burst-mode optical transmitter may be much longer than the data-burst intervals. In some other systems, the idle intervals of a burst-mode optical transmitter can be relatively short guard intervals configured to prevent collision and/or interference of data bursts transmitted to the same optical receiver by different optical transmitters.

In a passive optical network (PON), an optical network unit (ONU) may have a burst-mode optical transmitter. An optical line terminal (OLT) of the PON is typically configured to interact with a plurality of burst-mode optical transmitters of the ONUs.

### SUMMARY OF SOME SPECIFIC EMBODIMENTS

Disclosed herein are various embodiments of a coherent optical receiver capable of receiving data encoded in optical bursts whose optical power can vary significantly from burst to burst. Some embodiments of the coherent optical receiver are also capable of receiving data encoded in optical bursts whose carrier wavelength can change from burst to burst. In an example embodiment, the coherent optical receiver comprises a variable optical attenuator connected between an optical local oscillator and an optical hybrid and configured to controllably vary the intensity of the local-oscillator signal in response to a control signal generated by a control circuit. In an example embodiment, the control circuit is configured to generate the control signal for the variable optical attenuator using power-control settings read from a memory and further using a transmission schedule according to which different remote optical transmitters are scheduled to transmit their respective optical bursts. The power-control settings can be loaded into the memory, e.g., using a suitable calibration method configured to determine a respective nearly optimal coherent gain for receiving data from each of the remote optical transmitters.

In some embodiments, the optical local oscillator comprises a tunable laser, and the control circuit is further configured to generate a control signal for the laser using wavelength settings read from the memory. The wavelength settings can be loaded into the memory, e.g., using a suitable calibration method configured to determine a respective nearly optimal local-oscillator wavelength for receiving data from each of the remote optical transmitters.

In an example embodiment, a disclosed coherent optical receiver can be used to implement an optical line terminal of a passive optical network.

According to an example embodiment, provided is an apparatus comprising: a coherent optical receiver that comprises a laser, an optical power-control unit, an optical mixer, and one or more photodetectors, the optical mixer being configured to mix an optical input signal and an optical local-oscillator signal and apply one or more resulting mixed optical signals to the one or more photodetectors, the optical power-control unit being connected between the laser and the optical mixer; and a control circuit operatively coupled to the coherent optical receiver; wherein the control circuit comprises a memory configured to store therein a plurality of power-control settings, each of the power-control settings corresponding to a respective one of a plurality of remote optical transmitters; and wherein the optical power-control unit is configured to controllably change intensity of the optical local-oscillator signal in response to a first control signal generated by the control circuit, the first control signal being generated using at least some of the power-control settings stored in the memory.

According to another example embodiment, provided is an apparatus comprising: a coherent optical receiver that comprises a laser, an optical power-control unit, an optical mixer, and one or more photodetectors, the optical mixer being configured to mix an optical input signal and an optical local-oscillator signal and apply one or more resulting mixed optical signals to the one or more photodetectors, the optical power-control unit being connected between the laser and the optical mixer; and an electronic controller configured to store a plurality of power-control settings corresponding to a plurality of remote optical transmitters; and wherein the optical power-control unit is configured to controllably set an intensity of the optical local-oscillator signal based on the power-control settings stored in the electronic controller.

### BRIEF DESCRIPTION OF THE DRAWINGS

Other aspects, features, and benefits of various disclosed embodiments will become more fully apparent, by way of example, from the following detailed description and the accompanying drawings, in which:

FIG. 1 shows a block diagram of a PON system in which various embodiments can be practiced;

FIG. 2 shows a block diagram of an optoelectronic circuit that can be used in the PON system of FIG. 1 according to an embodiment;

FIG. 3 shows a flowchart of a calibration method that can be used in the PON system of FIG. 1 according to an embodiment;

FIGS. 4A-4B illustrate another calibration method that can be used in the PON system of FIG. 1 according to an embodiment; and

FIG. 5 shows a flowchart of an operating method that can be used in the PON system of FIG. 1 according to an embodiment.

### DETAILED DESCRIPTION

Some embodiments disclosed herein may benefit from the use of at least some features disclosed in U.S. patent application Ser. No. 15/696,939, which is incorporated herein by reference in its entirety.

A passive optical network (PON) typically has a point-to-multipoint architecture in which passive optical splitters are used to enable a single optical transmitter to broadcast data transmissions to multiple subscribers. An example PON includes an optical line terminal (OLT) at the service provider's central office (CO) and a plurality of optical network units (ONUs) near or at the individual end users. The ONUs are typically connected to the OLT by way of one or more passive optical splitters. Downlink signals are usually broadcast to all ONUs. Uplink signals are routed using a multiple access protocol, e.g., usually time division multiple access (TDMA). A PON is capable of advantageously reducing the amount of fiber, CO equipment, and active traffic-management equipment, e.g., compared to that required for point-to-point architectures.

In a wavelength-division-multiplexing PON (WDM-PON), multiple carrier wavelengths are used, for traffic in the same direction, e.g., downstream or upstream, over the same fiber network, thereby potentially providing better scalability and other benefits. An example WDM-PON architecture is disclosed, e.g., in U.S. Pat. No. 8,923,672, which is incorporated herein by reference in its entirety.

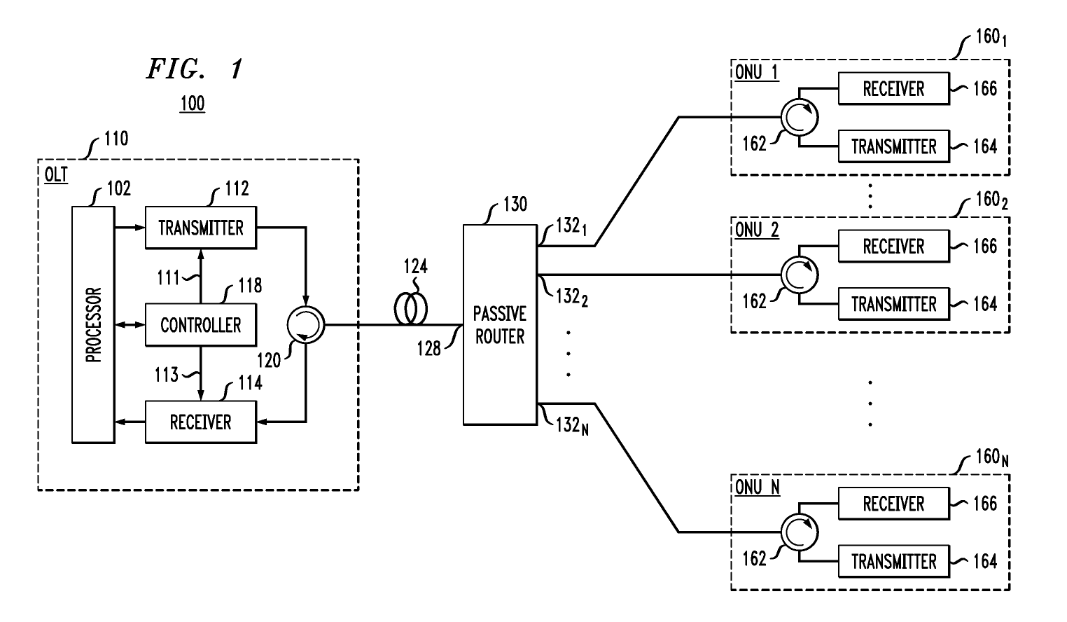

FIG. 1 shows a block diagram of a PON system 100 in which various embodiments can be practiced. System 100 has an OLT 110 configured to communicate with ONUs 160₁-160_{N}. In an example embodiment, the number N can be in the range from 8 to 256. In some embodiments, ONUs 160₁-160_{N} can be configured to use (nominally) the same carrier wavelength for uplink transmissions. In some other embodiments, ONUs 160₁-160_{N} can be configured to use different respective carrier wavelengths for uplink transmissions.

OLT 110 comprises an optical transmitter 112 and an optical receiver 114, both coupled, by way of an optical circulator 120 or other suitable optical coupler, to an optical fiber 124. Operation, functions, and configurations of transmitter 112 and receiver 114 can be managed and controlled using control signals 111 and 113 generated by an electronic controller 118. A processor 102 that is operatively coupled to transmitter 112, receiver 114, and controller 118 can be used for signal and data processing and, optionally, for supporting some functions of the controller. In an example embodiment, optical fiber 124 can have a length between about 1 km and about 40 km.

Transmitter 112 is configured to broadcast downlink signals to ONUs 160₁-160_{N} using one or more downlink carrier wavelengths. Receiver 114 is configured to receive uplink signals from ONUs 160₁-160_{N} transmitted using one or more uplink carrier wavelengths. Time-division multiplexing, e.g., by way of a suitable TDMA protocol executed using controller 118, can be used to prevent collisions, at receiver 114, between the uplink signals generated by different ONUs 160.

Optical fiber 124 connects OLT 110 to a passive router 130. Depending on the embodiment, router 130 can be implemented using: (i) a (1×N) passive optical splitter/combiner; (ii) a passive wavelength router (e.g., an arrayed waveguide grating, AWG); or (iii) any suitable combination of wavelength-insensitive and/or wavelength-sensitive passive optical elements. In an example embodiment, router 130 has (N+1) optical ports, including a single port 128 at its first or uplink side and a set of N ports 132₁-132_{N} at its second or downlink side. Herein, the term “side” is used in an abstract sense to indicate “uplink” or “downlink” directions rather than in a physical-orientation sense. Port 128 is internally optically connected to each of ports 132₁-132_{N}. Port 128 is externally optically connected to optical fiber 124 as indicated in FIG. 1. Ports 132₁-132_{N} are externally optically connected to ONUs 160₁-160_{N}, respectively, e.g., via optical fibers or more complex, passive optical-fiber networks, as further indicated in FIG. 1. Example devices that can be used to implement router 130 are disclosed, e.g., in the above-cited U.S. patent application Ser. No. 15/696,939 and U.S. Pat. No. 8,923,672.

In an example embodiment, each of ONUs 160₁-160_{N} includes a respective optical circulator 162 or other suitable optical coupler, a respective optical transmitter 164, and a respective optical receiver 166. Optical circulator 162 is configured to (i) direct downlink signals received from router 130 to optical receiver 166 and (ii) direct uplink signals from optical transmitter 164 to router 130.

In some embodiments, system 100 can be configured to operate such that all downlink signals are spectrally located in a spectral band near 1.55 μm, and all uplink signals are spectrally located in a spectral band near 1.3 μm, or vice versa. In such embodiments, all or some of optical circulators 120 and 162 may be replaced by respective optical pass-band or dichroic optical filters.

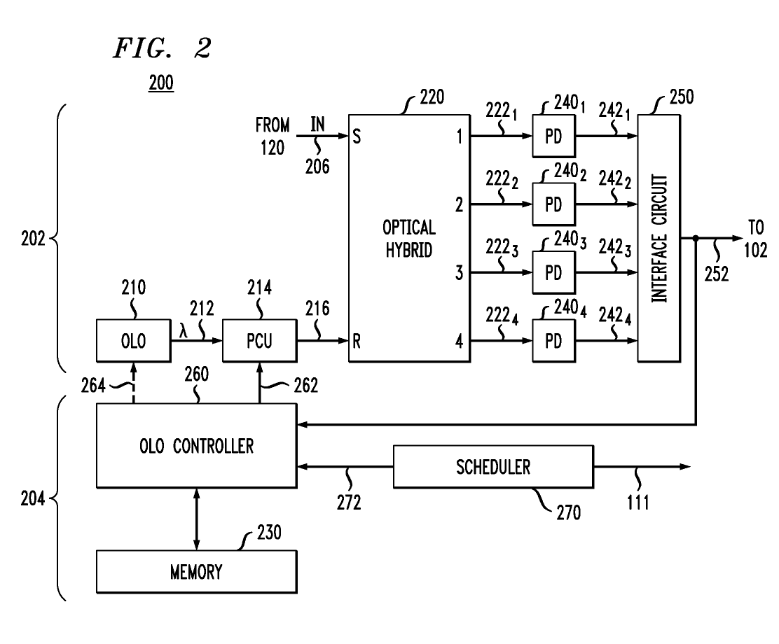

Certain operating methods and optoelectronic circuits that can be used in various embodiments of system 100 are described in more detail below in reference to FIGS. 2-5.

While FIG. 1 illustrates a PON with a single passive optical router 130, various possible embodiments are not so limited and may have more-complex PON architectures, e.g., having multiple passive optical routers and tree-like topologies.

FIG. 2 shows a block diagram of an optoelectronic circuit 200 that can be used in OLT 110 according to an embodiment. More specifically, circuit 200 can be used to implement at least some portions of receiver 114 and controller 118.

Circuit 200 comprises a coherent optical receiver 202 and a control circuit 204. Receiver 202 includes an optical-local-oscillator (OLO) source (e.g., laser) 210, an OLO power-control unit (PCU) 214, an optical hybrid 220, photodetectors 240₁-240₄, and an interface circuit 250. Control circuit 204 comprises a memory 230, an OLO controller 260, and a scheduler 270 operatively connected to receiver 202 as indicated in FIG. 2.

Receiver 202 is configured to: (i) receive a modulated optical input signal 206, e.g., from one or more transmitters 164, by way of optical fiber 124 (see FIG. 1); and (ii) generate one or more electrical output signals 252 from which the data encoded in signal 206 can be recovered, e.g. using processor 102. Control circuit 204 is configured to control the gain of receiver 202 and, in some embodiments, the output wavelength of OLO source 210, e.g., as described in more detail below. In an example embodiment, receiver 202 is configured to receive and process an optical input signal 206 that is not polarization-division multiplexed. However, a person of ordinary skill in the art will understand, without undue experimentation, how to modify receiver 202 for handling polarization-division multiplexed signals. Example modulation formats that can be used by transmitters 164 for generating signal 206 may include, but are not limited to binary phase-shift keying (BPSK), quadrature phase-shift keying (QPSK), on/off keying (OOK), and pulse amplitude modulation (PAM).

As used herein, the term “optical hybrid” refers to an optical mixer designed to mix a first optical input signal having a carrier frequency and a second optical input signal having approximately the same (e.g., to within ±25 GHz) carrier frequency to generate a plurality of mixed optical signals corresponding to different relative phase shifts between the two optical input signals. An optical 90-degree hybrid is a particular type of an optical hybrid that is designed to produce at least four mixed optical signals corresponding to the relative phase shifts between the two optical input signals of approximately 0, 90, 180, and 270 degrees, respectively (e.g., to within an acceptable tolerance). Depending on the intended application, the acceptable relative phase-shift tolerances can be, e.g., to within ±5 degrees or ±10 degrees, etc. A person of ordinary skill in the art will understand that each of the relative phase shifts is defined without accounting for a possible additional phase shift that is an integer multiple of 360 degrees. A dual-polarization optical hybrid operates to perform the above-indicated optical signal mixing on a per-polarization basis. In an example embodiment, optical hybrid 220 is an optical 90-degree hybrid having input ports S and R and output ports 1-4. Input port S is configured to receive optical input signal 206. Input port R is configured to receive an OLO signal 216 generated using OLO source 210 and PCU 214 as further described below. Optical hybrid 220 operates in a conventional manner to mix signals 206 and 216 to generate four mixed (e.g., optical interference) signals 2221-2224 at output ports 1-4, respectively. Optical signals 2221-2224 are then detected by four photodetectors (e.g., photodiodes) 2401-2404. The resulting electrical signals generated by photodiodes 2401-2404 are electrical signals 242₁-242₄ that are applied to interface circuit 250.

In some embodiments, photodiodes 2401-2404 may be configured to operate, e.g., as two balanced detectors, each of the balanced detectors having a respective pair of the photodiodes.

In an alternative embodiment, optical hybrid 220 can be replaced by any suitable optical mixer, e.g., an optical coupler. In some embodiments, such an optical mixer may have fewer or more than four optical output ports and/or more than two optical input ports.

Example circuits that can be used to implement interface circuit 250 are disclosed, e.g., in the above-cited U.S. patent application Ser. No. 15/696,939. A person of ordinary skill in the art will understand that other suitable interface circuits may also be used to implement interface circuit 250.

In a typical embodiment of system 100, optical input signal 206 delivers bursts of modulated light (e.g., optical packets) that originated from different ONUs 160. Due to the different optical paths that the different optical bursts traverse en route to OLT 110, the average optical power of different optical bursts may vary significantly (e.g., as much as by ˜10 dB). Both the bursty nature and burst-to-burst power fluctuations of optical input signal 206 present certain challenges to the design and operation of OLT 110.

Embodiments disclosed herein address the above-indicated problems by providing methods and apparatus for controlling the gain of receiver 202 in a manner that causes undesirable fluctuations of optical signals 222₁-222₄ and electrical signals 242₁-242₄ to be significantly reduced compared to those of the corresponding optical input signal 206. As a result, OLT 110 is advantageously capable of performing better than comparable conventional OLTs under similar operating conditions.

In an example embodiment, the use of optical hybrid 220 causes each of electrical signals 242₁-242₄ to be approximately proportional to the product of the electric-field strengths of optical signals 206 and 216. As a result, a preferred level of electrical signals 242₁-242₄ can be achieved by appropriately controlling the intensity of OLO signal 216. For example, if an optical burst delivered by optical input signal 206 is relatively weak (or strong), then the intensity of OLO signal 216 can be increased (or decreased) accordingly to keep electrical signals 242₁-242₄ within a preferred (e.g., relatively narrow) strength range. The latter performance characteristic can be achieved using control circuit 204, e.g., as further described below.

In an example embodiment, scheduler 270 operates to control a schedule according to which different ONUs 160₁-160_{N} transmit their respective optical bursts. This schedule may include two or more sub-schedules corresponding to different operating modes. For example, during a regular operating mode, ONUs 160₁-160_{N} may take turns to transmit on a preset schedule, in which each ONU is allocated respective scheduled time slots for transmission. During a scheduled time slot allocated to a particular ONU, only that ONU can transmit to OLT 110, while the other ONUs are “silent.” As another example, during a calibration mode, scheduler 270 may use control signal 111 to request transmissions from any one or any subset of ONUs 160₁-160_{N}.

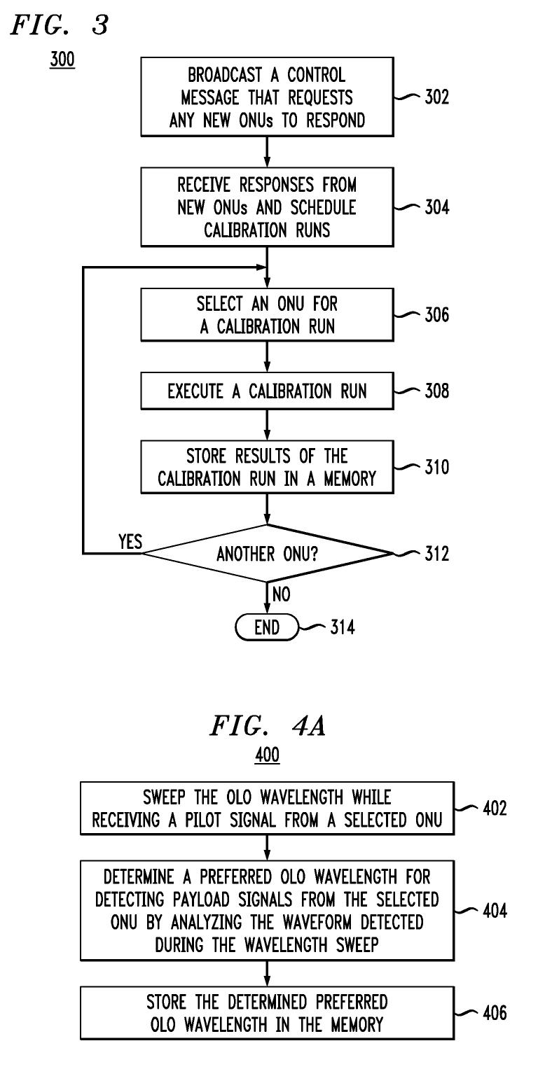

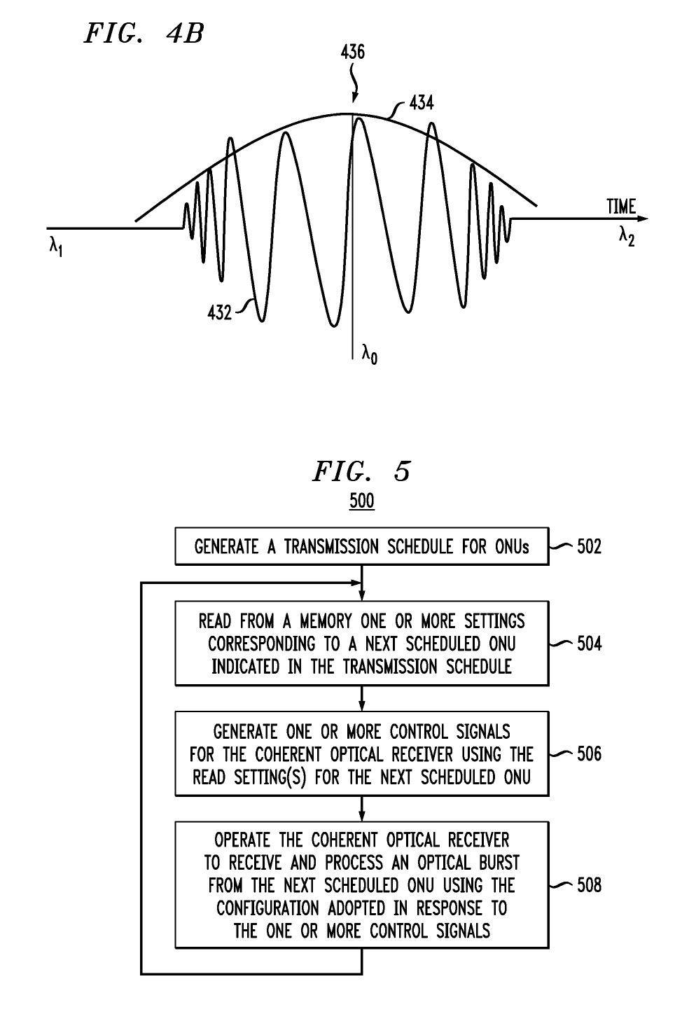

In an example embodiment, a calibration mode can be used to determine (i) a respective preferred intensity of OLO signal 216 for each ONU 160 and (ii) in some embodiments, a respective preferred wavelength of OLO signal 216 for each ONU 160. Memory 230 can be used to store the calibration results, e.g., in the form of a look-up table (LUT), wherein each ONU 160 has an entry that specifies a plurality of parameters, such as the corresponding attenuation/amplification settings for PCU 214 and, if applicable, the corresponding wavelength settings for OLO source 210. Example calibration methods that can be used by OLT 110 to generate the LUT entries for ONUs 160₁-160_{N} are described in more detail below in reference to FIGS. 3-4.

During a regular operating mode, scheduler 270 supplies to OLO controller 260, e.g., by way of a control signal 272, the applicable transmission schedule according to which ONUs 160₁-160_{N} are going to transmit their respective optical bursts. Using this transmission schedule and the calibration results retrieved from the LUT stored in memory 230, OLO controller 260 operates to generate a control signal 262 and, in some embodiments, a control signal 264. In each time slot, control signal 262 causes PCU 214 to apply the corresponding level of attenuation or amplification to an optical signal 212 received from OLO source 210, thereby causing OLO signal 216 to have a proper intensity for the corresponding optical burst delivered by signal 206 to be nearly optimally converted into electrical signals 242₁-242₄. Thus, adjusting the intensity of OLO signal 216, in some sense, can be understood as being a mechanism for adjusting the gain of receiver 202. If applicable, control signal 264 can be used to cause OLO source 210 to generate optical signal 212 such that it has a nearly optimal wavelength for such optical-to-electrical conversion in the corresponding time slot.

In an example embodiment, PCU 214 can be implemented using, e.g., (i) a fast variable optical attenuator, (ii) a fast optical amplifier, or (iii) any suitable combination of (i) and (ii). As used herein, the term “fast” should be interpreted to indicate a capability of the corresponding optical device to substantially complete the change of the attenuation or amplification level applied thereby on a time scale approximately corresponding to the time interval between adjacent transmission time slots.

In an example embodiment, OLO source 210 can be implemented using, e.g., (i) a laser whose output wavelength λ is fixed or (ii) a tunable laser whose output wavelength λ can be changed in response to control signal 264. If a tunable laser is used, then the tunable laser preferably has sufficiently fast tunability that enables the intended change of wavelength λ to be substantially completed within the time interval between adjacent transmission time slots.

FIG. 3 shows a flowchart of a calibration method 300 that can be used in system 100 according to an embodiment. Method 300 can be used, e.g., to generate LUT entries for different ONUs 160.

At step 302 of method 300, OLT 110 operates to broadcast a control message that requests any new ONUs 160 to respond. During the initial deployment or full reset of system 100, all ONUs 160 are considered to be “new.” During a subsequent expansion or configuration change of system 100, only the recently added ONUs 160 are considered to be “new.”

At step 304, OLT 110 receives responses from the “new” ONUs 160 and generates a schedule of calibration runs for such “new” ONUs 160.

At step 306, OLT 110 uses the schedule generated at step 304 to select a next ONU 160 for a corresponding calibration run.

At step 308, OLT 110 and the ONU 160 selected at step 306 execute a calibration run. As used herein, the term “calibration run” refers to a set of test and/or pilot signals exchanged by OLT 110 and the selected ONU 160, with the test/pilot signals being designed and configured to enable the determination of certain characteristics of and parameters for operating the optical link therebetween. The characteristics/parameters that can be determined in this manner may include one or more of: (i) a signal-delay time; (ii) a receive optical power at input port S (FIG. 2); (iii) an effective carrier wavelength of input signal 206 (FIG. 2); (iv) a preferred wavelength for OLO signal 216 (FIG. 2); (v) a preferred amplification/attenuation setting for PCU 214 (FIG. 2), etc.

At step 310, the characteristics/parameters determined at step 308 are stored in memory 230 (FIG. 2), e.g., in the form of the corresponding LUT entry.

At step 312, OLT 110 uses the schedule generated at step 304 to determine whether or not there is at least another “new” ONU 160 that needs to go through a calibration run. If yes, then the processing of method 300 is directed back to step 306. Otherwise, the processing of method 300 is directed to step 314, where it is terminated.

FIGS. 4A-4B illustrate a calibration method 400 that can be used in system 100 according to an embodiment. More specifically, FIG. 4A shows a flowchart of method 400. FIG. 4B graphically illustrates the signal processing that can be implemented in method 400. In some embodiments, method 400 can be used to implement a portion of step 308 of method 300 (FIG. 3). In some other embodiments, method 400 can be used to adjust the wavelength λ of optical signal 212 (FIG. 2) on the fly, e.g., during a preamble portion of an optical burst.

Referring to FIG. 4A, at step 402 of method 400, OLO controller 260 generates a control signal 264 that configures OLO source 210 to sweep the wavelength λ of optical signal 212 (FIG. 2) from wavelength λ₁ to wavelength λ₂. In an example embodiment, the wavelengths λ₁ and λ₂ can be selected to be smaller and greater, respectively, of the nominal carrier wavelength used by the corresponding ONU 160. In some embodiments, the wavelengths λ₁ and λ₂ can be (slightly) out of band with respect to the corresponding wavelength channel on opposite spectral sides thereof. The wavelength sweep can be performed, e.g., in an approximately linear manner.

At step 404, OLO controller 260 operates to process an electrical signal generated by receiver 202 during the wavelength sweep to determine a preferred OLO wavelength for detecting payload signals from the corresponding ONU 160. An example of such processing is graphically illustrated in FIG. 4B.

Referring to FIG. 4B, a waveform 432 illustrates an example signal 242 or 252 that can be generated during the above-indicated wavelength sweep. The wavelength sweep corresponding to waveform 432 begins at wavelength ki and ends at wavelength λ₂. When the wavelength of optical signal 212 is out of band at the beginning of the wavelength sweep, waveform 432 is flat-lined at the zero level. When the wavelength of optical signal 212 is in band, waveform 432 has oscillations, the changing frequency of which tracks the wavelength difference between optical signals 212 and 206, and the changing amplitude of which reflects the spectral properties of the corresponding wavelength channel. When the wavelength of optical signal 212 goes out of band at the end of the wavelength sweep, waveform 432 is again flat-lined at the zero level.

An envelope 434 of the oscillating portion of waveform 432 can be detected, e.g., as known in the pertinent art, and then analyzed to find a maximum 436 thereof. The position of maximum 436 can then be used to determine the corresponding wavelength λ₀ of optical signal 212 during the wavelength sweep. The wavelength λ₀ determined in this manner can then be designated as the preferred OLO wavelength for detecting payload signals from the corresponding ONU 160.

Referring back to FIG. 4A, at step 406 of method 400, the wavelength λ₀ determined at step 404 is stored in memory 230 in the appropriate field of the LUT entry corresponding to the ONU 160 in question.

In some embodiments, step 406 is optional and can be omitted. In such embodiments, the wavelength λ₀ can be determined during a preamble portion of the optical burst and then used to set the wavelength of optical signal 212 for detecting the payload portion of the same optical burst.

FIG. 5 shows a flowchart of a communication method 500 that can be used in system 100 according to an embodiment. Method 500 can be used, e.g., when system 100 is in a regular operating mode.

At step 502 of method 500, scheduler 270 generates a transmission schedule according to which different ONUs 160 are going to transmit their respective optical bursts (e.g., carrying data packets). In an example embodiment, any suitable TDMA protocol can be used to generate the transmission schedule. The generated schedule is then provided, by way of control signal 272 to OLO controller 260.

At step 504, OLO controller 260 operates to read from memory 230 a LUT entry corresponding to the ONU 160 that is to transmit next according to the transmission schedule of step 502.

At step 506, OLO controller 260 operates to generate control signal 262 and, in some embodiments, control signal 264 based on the LUT entry read at step 504. As already explained above, control signals 262 and 264 generated in this manner configure PCU 214 and OLO source 210, respectively, to cause OLO signal 216 to have a nearly optimal intensity and a nearly optimal wavelength for detecting payload signals received from the scheduled ONU 160.

At step 508, receiver 202 operates to receive and process an optical burst from the scheduled ONU 160 using the configuration of step 506.

In some embodiments, circuit 200 may optionally be configured to perform one or more of the following during the preamble portion of the optical burst: (A) fine-tune the OLO wavelength generated by OLO source 210; (B) fine-tune the attenuation/amplification settings of PCU 214; and (C) update the corresponding LUT entry in memory 230 based on the results of the fine-tuning of sub-steps (A) and/or (B). Sub-step (A) can be performed, e.g., using a suitable embodiment of method 400. Sub-step (B) can be implemented, e.g., using an approach similar to that disclosed in European Patent No. 2,273,700, which is incorporated herein by reference in its entirety.

Upon the completion of step 508, the processing of method 500 is directed back to step 504.

According to an example embodiment disclosed above, e.g., in the summary section and/or in reference to any one or any combination of some or all of FIGS. 1-5, provided is an apparatus (e.g., 100 or 110, FIG. 1) comprising: a coherent optical receiver (e.g., 202, FIG. 2) that comprises a laser (e.g., 210, FIG. 2), an optical power-control unit (e.g., 214, FIG. 2), an optical mixer (e.g., 220, FIG. 2), and one or more photodetectors (e.g., 240, FIG. 2), the optical mixer being configured to mix an optical input signal (e.g., 206, FIG. 2) and an optical local-oscillator signal (e.g., 216, FIG. 2) and apply one or more resulting mixed optical signals (e.g., 222, FIG. 2) to the one or more photodetectors, the optical power-control unit being connected between the laser and the optical mixer; and a control circuit (e.g., 204, FIG. 2) operatively coupled to the coherent optical receiver; wherein the control circuit comprises a memory (e.g., 230, FIG. 2) configured to store therein a plurality of power-control settings, each of the power-control settings corresponding to a respective one of a plurality of remote optical transmitters (e.g., 164, FIG. 1); and wherein the optical power-control unit is configured to controllably change intensity of the optical local-oscillator signal in response to a first control signal (e.g., 262, FIG. 2) generated by the control circuit, the first control signal being generated using at least some of the power-control settings stored in the memory.

In some embodiments of the above apparatus, the control circuit further comprises a scheduler (e.g., 270, FIG. 2) configured to set a transmission schedule according to which optical bursts are to be transmitted by different ones of the plurality of remote optical transmitters to the coherent optical receiver; and the control circuit is configured to generate the first control signal using the transmission schedule.

In some embodiments of any of the above apparatus, the control circuit is configured to: read (e.g., at 504, FIG. 5) from the memory a power-control setting corresponding to a next scheduled remote optical transmitter indicated in the transmission schedule; and generate (e.g., at 506, FIG. 5) the first control signal using the power-control setting corresponding to the next scheduled remote optical transmitter.

In some embodiments of any of the above apparatus, the scheduler is configured to set the transmission schedule using a time-division-multiple-access protocol.

In some embodiments of any of the above apparatus, the memory is further configured to store therein a plurality of wavelength settings, each of the wavelength settings corresponding to a respective one of the plurality of remote optical transmitters; and the laser is a tunable laser configured to change a wavelength of the optical local-oscillator signal in response to a second control signal (e.g., 264, FIG. 2) generated by the control circuit, the second control signal being generated using at least some of the wavelength settings stored in the memory.

In some embodiments of any of the above apparatus, the control circuit further comprises a scheduler (e.g., 270, FIG. 2) configured to set a transmission schedule according to which optical bursts are to be transmitted by different ones of the plurality of remote optical transmitters to the coherent optical receiver; and the control circuit is configured to generate the first and second control signals using the transmission schedule.

In some embodiments of any of the above apparatus, the control circuit is configured to: read (e.g., at 504, FIG. 5) from the memory a wavelength setting corresponding to a next scheduled remote optical transmitter indicated in the transmission schedule; and generate (e.g., at 506, FIG. 5) the second control signal using the wavelength setting corresponding to the next scheduled remote optical transmitter.

In some embodiments of any of the above apparatus, the plurality of wavelength settings comprises calibration data (e.g., obtained using 400, FIG. 4) corresponding to the plurality of remote optical transmitters.

In some embodiments of any of the above apparatus, the control circuit is configured to: receive a feedback signal (e.g., 252, FIG. 2) from the one or more photodetectors; and generate and store in the memory (e.g., using 300, FIG. 3; 400, FIG. 4) at least some of the plurality of wavelength settings using the feedback signal.

In some embodiments of any of the above apparatus, the control circuit is configured to: receive a feedback signal (e.g., 252, FIG. 2) from the one or more photodetectors; and generate and store in the memory (e.g., using 300, FIG. 3) at least some of the plurality of power-control settings using the feedback signal.

In some embodiments of any of the above apparatus, the plurality of power-control settings comprises calibration data corresponding to a plurality of optical links, each of the optical links being an optical link between the coherent optical receiver and a respective one of the plurality of remote optical transmitters.

In some embodiments of any of the above apparatus, the coherent optical receiver is capable of recovering data encoded in optical bursts of the optical input signal, at least some of the optical bursts having different respective carrier wavelengths.

In some embodiments of any of the above apparatus, the apparatus further comprises a passive optical router (e.g., 130, FIG. 1) having a first optical port (e.g., 128, FIG. 1) and a plurality of second optical ports (e.g., 132, FIG. 1), the first optical port being connected to the coherent optical receiver, and each of the second optical ports being connected to a respective one of the plurality of remote optical transmitters.

In some embodiments of any of the above apparatus, the apparatus further comprises a passive optical network (e.g., 100, FIG. 1); and wherein the passive optical network comprises the coherent optical receiver and the plurality of remote optical transmitters.

In some embodiments of any of the above apparatus, the optical mixer comprises an optical 90-degree hybrid (e.g., 220, FIG. 2).

In some embodiments of any of the above apparatus, the optical power-control unit comprises a variable optical attenuator configured to change signal attenuation therein in response to the first control signal.

In some embodiments of any of the above apparatus, the optical power-control unit comprises an optical amplifier configured to change signal amplification therein in response to the first control signal.

According to another example embodiment disclosed above, e.g., in the summary section and/or in reference to any one or any combination of some or all of FIGS. 1-5, provided is an apparatus (e.g., 100 or 110, FIG. 1) comprising: a coherent optical receiver (e.g., 202, FIG. 2) that comprises a laser (e.g., 210, FIG. 2), an optical power-control unit (e.g., 214, FIG. 2), an optical mixer (e.g., 220, FIG. 2), and one or more photodetectors (e.g., 240, FIG. 2), the optical mixer being configured to mix an optical input signal and an optical local-oscillator signal and apply one or more resulting mixed optical signals to the one or more photodetectors, the optical power-control unit being connected between the laser and the optical mixer; and an electronic controller (e.g., 118, FIG. 1) configured to store a plurality of power-control settings corresponding to a plurality of remote optical transmitters (e.g., 164, FIG. 1); and wherein the optical power-control unit is configured to controllably set an intensity of the optical local-oscillator signal based on the power-control settings stored in the electronic controller.

In some embodiments of any of the above apparatus, the electronic controller and the optical power-control unit are configured to change the intensity of the optical local-oscillator signal by applying the power-control settings in a sequence in which optical bursts from different remote optical transmitters are received at the coherent optical receiver. In some embodiments of any of the above apparatus, the electronic controller is configured to control the optical power-control unit based on a schedule for receiving, at the coherent optical receiver, optical bursts from the plurality of remote optical transmitters.

In some embodiments of any of the above apparatus, the schedule is set using a time-division-multiple-access protocol.

In some embodiments of any of the above apparatus, the electronic controller is further configured to store therein a plurality of wavelength settings, each of the wavelength settings corresponding to a respective one of the remote optical transmitters; the laser is a tunable laser; and the apparatus is configured to set an output wavelength of the laser based on some of the wavelength settings stored in the electronic controller.

While this disclosure includes references to illustrative embodiments, this specification is not intended to be construed in a limiting sense. Various modifications of the described embodiments, as well as other embodiments within the scope of the disclosure, which are apparent to persons skilled in the art to which the disclosure pertains are deemed to lie within the principle and scope of the disclosure, e.g., as expressed in the following claims.

Unless explicitly stated otherwise, each numerical value and range should be interpreted as being approximate as if the word “about” or “approximately” preceded the value or range.

It will be further understood that various changes in the details, materials, and arrangements of the parts which have been described and illustrated in order to explain the nature of this disclosure may be made by those skilled in the art without departing from the scope of the disclosure, e.g., as expressed in the following claims.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

What is claimed is:

1. An apparatus comprising:
a coherent optical receiver that comprises a laser, an optical power-control unit, an optical mixer, and one or more photodetectors, the optical mixer being configured to mix an optical input signal and an optical local-oscillator signal and apply one or more resulting mixed optical signals to the one or more photodetectors, the optical power-control unit being connected between the laser and the optical mixer; and
an electronic controller configured to store a plurality of power-control settings corresponding to a plurality of remote optical transmitters; and
wherein the optical power-control unit is configured to controllably set an intensity of the optical local-oscillator signal based on the power-control settings stored in the electronic controller.

2. The apparatus of claim 1, wherein the electronic controller and the optical power-control unit are configured to change the intensity of the optical local-oscillator signal by applying the power-control settings in a sequence in which optical bursts from different remote optical transmitters are received at the coherent optical receiver.

3. The apparatus of claim 1, wherein the electronic controller is configured to control the optical power-control unit based on a schedule for receiving, at the coherent optical receiver, optical bursts from the plurality of remote optical transmitters.

4. The apparatus of claim 3, wherein the schedule is set using a time-division-multiple-access protocol.

5. The apparatus of claim 1,
wherein the electronic controller is further configured to store therein a plurality of wavelength settings, each of the wavelength settings corresponding to a respective one of the remote optical transmitters;
wherein the laser is a tunable laser; and
wherein the apparatus is configured to set an output wavelength of the laser based on some of the wavelength settings stored in the electronic controller.

6. An apparatus comprising:
a coherent optical receiver that comprises a laser, an optical power-control unit, an optical mixer, and one or more photodetectors, the optical mixer being configured to mix an optical input signal and an optical local-oscillator signal and apply one or more resulting mixed optical signals to the one or more photodetectors, the optical power-control unit being connected between the laser and the optical mixer; and
a control circuit operatively coupled to the coherent optical receiver;
wherein the control circuit comprises a memory configured to store therein a plurality of power-control settings, each of the power-control settings corresponding to a respective one of a plurality of remote optical transmitters; and
wherein the optical power-control unit is configured to controllably change intensity of the optical local-oscillator signal in response to a first control signal generated by the control circuit, the first control signal being generated using at least some of the power-control settings stored in the memory.

7. The apparatus of claim 6,
wherein the control circuit further comprises a scheduler configured to set a transmission schedule according to which optical bursts are to be transmitted by different ones of the plurality of remote optical transmitters to the coherent optical receiver; and
wherein the control circuit is configured to generate the first control signal using the transmission schedule.

8. The apparatus of claim 7, wherein the control circuit is configured to:
read from the memory a power-control setting corresponding to a next scheduled remote optical transmitter indicated in the transmission schedule; and
generate the first control signal using the power-control setting corresponding to the next scheduled remote optical transmitter.

9. The apparatus of claim 7, wherein the scheduler is configured to set the transmission schedule using a time-division-multiple-access protocol.

10. The apparatus of claim 6,
wherein the memory is further configured to store therein a plurality of wavelength settings, each of the wavelength settings corresponding to a respective one of the plurality of remote optical transmitters; and
wherein the laser is a tunable laser configured to change a wavelength of the optical local-oscillator signal in response to a second control signal generated by the control circuit, the second control signal being generated using at least some of the wavelength settings stored in the memory.

11. The apparatus of claim 10,
wherein the control circuit further comprises a scheduler configured to set a transmission schedule according to which optical bursts are to be transmitted by different ones of the plurality of remote optical transmitters to the coherent optical receiver;
wherein the control circuit is configured to:
generate the first and second control signals using the transmission schedule;
read from the memory a wavelength setting corresponding to a next scheduled remote optical transmitter indicated in the transmission schedule; and
generate the second control signal using the wavelength setting corresponding to the next scheduled remote optical transmitter.

12. The apparatus of claim 10, wherein the plurality of wavelength settings comprises calibration data corresponding to the plurality of remote optical transmitters.

13. The apparatus of claim 10, wherein the control circuit is configured to:
receive a feedback signal from the one or more photodetectors; and
generate and store in the memory at least some of the plurality of wavelength settings using the feedback signal.

14. The apparatus of claim 6, wherein the control circuit is configured to:
receive a feedback signal from the one or more photodetectors; and
generate and store in the memory at least some of the plurality of power-control settings using the feedback signal.

15. The apparatus of claim 6, wherein the plurality of power-control settings comprises calibration data corresponding to a plurality of optical links, each of the optical links being an optical link between the coherent optical receiver and a respective one of the plurality of remote optical transmitters.

16. The apparatus of claim 6, wherein the coherent optical receiver is capable of recovering data encoded in optical bursts of the optical input signal, at least some of the optical bursts having different respective carrier wavelengths.

17. The apparatus of claim 6, further comprising a passive optical router having a first optical port and a plurality of second optical ports, the first optical port being connected to the coherent optical receiver, and each of the second optical ports being connected to a respective one of the plurality of remote optical transmitters.

18. The apparatus of claim 6, wherein the optical mixer comprises an optical 90-degree hybrid.

19. The apparatus of claim 6, wherein the optical power-control unit comprises a variable optical attenuator configured to change signal attenuation therein in response to the first control signal.

20. The apparatus of claim 6, wherein the optical power-control unit comprises an optical amplifier configured to change signal amplification therein in response to the first control signal.
